(19) United States
(12) Patent Application Publication
(10) Pub. No.: US 2025/0012507 A1
(43) Pub. Date: Jan. 9, 2025

(54) PRODUCTION LINE AND PRODUCTION METHOD FOR POSITIVE ELECTRODE MATERIAL OF LITHIUM-ION BATTERY

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Qian Wang, Foshan, Guangdong (CN); Changdong Li, Foshan, Guangdong (CN); Yong Zeng, Foshan, Guangdong (CN); Dingshan Ruan, Foshan, Guangdong (CN); Weijian Liu, Foshan, Guangdong (CN); Yong Cai, Foshan, Guangdong (CN)

(21) Appl. No.: 18/711,119

(22) PCT Filed: Aug. 23, 2022
(86) PCT No.: PCT/CN2022/114290

§ 371 Date: May 17, 2024

(30) Foreign Application Priority Data
Nov. 30, 2021 (CN) 202111439759.6

(51) Int. Cl. F27B 7/42; F27D 19/00; G01N 27/416; H01M 4/02; H01M 4/04

(52) U.S. Cl. CPC F27B 7/42; F27D 19/00; H01M 4/0471; F27D 2019/0012; F27M 2003/04; G01N 27/4162; H01M 2004/028

(57) ABSTRACT

Disclosed is a production line and production method for positive electrode material of a lithium-ion battery. The production line comprises a roller kiln; a gas collecting device communicated with the roller kiln and configured to collect gas inside the roller kiln; and a free lithium-measuring device configured to measure content of free lithium in the gas collected by the gas collecting device.

### TECHNICAL FIELD

The present disclosure belongs to the technical field of lithium-ion batteries, and in particular to a production line and production method of positive electrode material of a lithium-ion battery.

### BACKGROUND

At present, sintering of positive electrode material of a lithium-ion battery commonly use roller kiln, where a homogeneous mixture of precursors, lithium salt, and additives is sintered at a high temperature with a suitable sintering process under certain atmospheric conditions. Such a process is the key for preparing positive electrode materials with excellent electrochemical performance. And, the temperature control, pressure control and atmosphere control of the kiln are particularly important.

According to the structure of a kiln, the roller kiln can be divided into a preheating zone, a firing zone and a cooling zone. The preheating zone is located in the front section of the kiln, where raw materials are dehydrated and the produced waste gas is discharged out. The firing zone is located in the middle of the kiln, where the redox reaction for forming positive electrode materials mainly occurs. The cooling zone is located at the tail of the kiln, where the positive electrode material after high temperature sintering is cooled. In order to ensure that the sintering reaction goes well, it is usually necessary to introduce an excess of gas, but the excess coefficient of gas (air) should not be too large. If the excess coefficient is too large, the heat taken away by the exhausted gas will be too much, resulting in an increase of ambient temperature and waste of energy. If the introduced gas is insufficient, it will result in an insufficient reaction. At present, in the industry, commonly, whether the sintering parameters are appropriate or not is judged by evaluating the residual lithium, morphology, crystal structure, compaction density, specific surface area, particle size, and electrochemical properties of the products from the high temperature sintering. Such evaluation, however, has a problem of lag that when the evaluation results show a problem with the sintering parameters, the raw materials have been sintered into unqualified finished products, resulting in waste of raw materials.

### SUMMARY

The present disclosure aims to solve at least one of the technical problems existing in the prior art. For this purpose, the present invention proposes a production line and production method for positive electrode material of a lithium-ion battery. This production line for positive electrode material of a lithium-ion battery can monitor the state of free lithium in real time, so that sintering parameters can be evaluated in real time, so as to adjust the sintering parameters in real time, to reduce unqualified products, and to avoid waste of raw materials.

The above-mentioned technical purpose of the present disclosure is achieved through the following technical solutions:

A production line for positive electrode material of a lithium-ion battery comprises: a roller kiln; a gas collecting device, communicated with the roller kiln and configured to collect gas inside the roller kiln; and a free lithium-measuring device, configured to measure content of free lithium in the gas collected by the gas collecting device.

Preferably, the gas collecting device is communicated with a zero pressure position of the roller kiln, to collect the gas at the zero pressure position of the roller kiln. The zero pressure position refers to the position where the gas pressure in the roller kiln is equal to the external atmospheric pressure, which typically is between the preheating zone and the firing zone of the roller kiln.

Preferably, a gas filtering device is further connected to the gas collecting device.

Preferably, a filter membrane, with a pore size of 400-500 nm, is provided inside the gas filtering device.

Preferably, the free lithium-measuring device is a potentiometric titrator.

Provided is a production method for a positive electrode material of a lithium-ion battery comprising a step of monitoring free lithium in gas inside a roller kiln during sintering of a positive electrode material of a lithium-ion battery.

Preferably, the method comprises steps of: collecting gas inside a roller kiln by a gas collecting device and measuring content of free lithium in the collected gas by a free lithium-measuring device, during sintering of a positive electrode material of a lithium-ion battery.

Preferably, the time for single collection of the gas inside the roller kiln by the gas collecting device is 0.2-5 h.

Preferably, the time for single collection of the gas inside the roller kiln by the gas collecting device is 0.5-2 h.

A method of debugging a production line for a positive electrode material of a lithium-ion battery comprises steps of: monitoring free lithium in gas inside a roller kiln during sintering of a positive electrode material of a lithium-ion battery at a normal production line for a positive electrode material of a lithium-ion battery and a production line for a positive electrode material of a lithium-ion battery respectively, and adjusting intake and exhaust parameters of the debugging production line for a positive electrode material of a lithium-ion battery, to control content of free lithium in the debugging production line for a positive electrode material of a lithium-ion battery to be at the same level as that in the normal production line for a positive electrode material of a lithium-ion battery. Herein “same level” means that the difference in free lithium content measured per unit time between the normal production line for a positive electrode material of a lithium-ion battery and the debugging production line for a positive electrode material of a lithium-ion battery with the same specification is less than 0.1%.

The present disclosure has the following beneficial effects:

(1) The production line for positive electrode material of a lithium-ion battery of the present disclosure can monitor the state of free lithium in a roller kiln in real time, so that the sintering parameters can be evaluated in real time to advance the evaluation, which can effectively reduce the rate of unqualified products.

(2) The sintering process of positive electrode material of a lithium-ion battery is the process of lithium ions entering crystal lattices with lattice structure to form a new phase, in which most of the lithium ions enter into crystal lattices of the new phase, and a very small part is left as residual lithium at the surface of the materials. At a high temperature, a part of lithium is mixed with the waste gas generated from sintering in a form of gas and discharged into the atmosphere, while another part of lithium stays inside the atmosphere of the kiln in the free state, and finally deposits as lithium dendrites at the upper part of the inner wall of the kiln. According to the production method for positive electrode material of a lithium-ion battery of the present disclosure, the content of lithium free in the atmosphere in real time is monitored to judge whether the sintering process is reasonable or not, so that the sintering process can be adjusted in time, to avoid the problem of lag in the existing evaluation operation, and to reduce material loss in production line debugging and mass production introduction.

(3) The method for debugging a production line for positive electrode material of a lithium-ion battery of the present disclosure can be applied to the introduction of a new production line, which facilitates direct copying and pasting of processes, thereby improving product consistency.

### BRIEF DESCRIPTION OF DRAWINGS

FIG. 1 is a schematic drawing showing the production line for positive electrode material of a lithium-ion battery in Example 1 of the present disclosure.

### REFERENCE NUMBERS IN THE ACCOMPANYING DRAWINGS

100 roller kiln, 101 preheating zone, 102 firing zone, 103 cooling zone, 104 zero pressure position, 201 gas collecting device, 202 gas filtering device, 203 online potentiometric titrator.

### DETAILED DESCRIPTION OF EMBODIMENTS

The present disclosure will be further described below with reference to specific embodiments.

### EXAMPLES

### Example 1

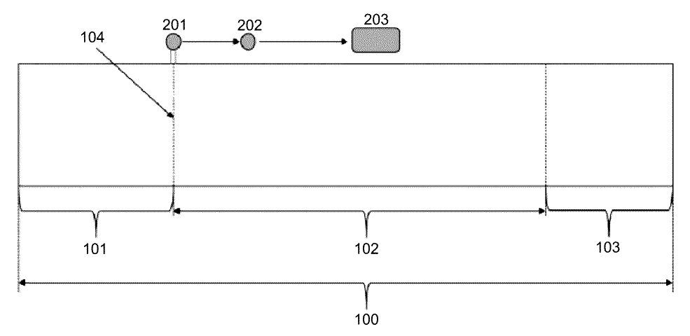

A production line for positive electrode material of a lithium-ion battery, as shown in FIG. 1, comprises a roller kiln 100, a gas collecting device 201, a gas filtering device 202 and an online potentiometric titrator 203. The roller kiln 100 comprises a preheating zone 101, a firing zone 102 and a cooling zone 103. The gas collecting device 201 is communicated with a zero pressure position 104 of the roller kiln 100, for collecting the gas at the zero pressure position 104 inside the roller kiln 100. The zero pressure position 104 is located between the preheating zone 101 and the firing zone 102 of the roller kiln 100. The gas filtering device 202 is connected with the gas collecting device 201. Filter membranes and deionized water are provided inside the gas filtering device 202. The filter membranes had a pore size of 400-500 nm. The online potentiometric titrator 203 is used to measure the content of free lithium in the gas collected by the gas collecting device 201.

### Example 2

A production method for positive electrode material of a lithium-ion battery comprises the following steps.
(1) During sintering of a positive electrode material of a lithium-ion battery, the gas at the zero pressure position 104 inside the roller kiln 100 was collected by the gas collecting device 201, at a single collection time of 0.2-5 h, preferably 0.5-2 h;
(2) Small particles suspended in the collected gas was removed by the gas filtering device 202 equipped with deionized water, to obtain a lithium-containing solution;
(3) The content of free lithium in the lithium-containing solution was measured by the online potentiometric titrator 203, and the measured free lithium content was divided by the collection time to obtain the free lithium content collected per unit time.

### Example 3

A method for debugging a production line for positive electrode material of a lithium-ion battery comprises the following steps: in a normal production line for positive electrode material of a lithium-ion battery and a debugging production line for positive electrode material of a lithium-ion battery, the production method for positive electrode material of a lithium-ion battery in Example 2 was adopted respectively, to monitor the free lithium in the gas inside the roller kiln during the sintering; and the intake and exhaust parameters of the debugging production line for positive electrode material of a lithium-ion battery were adjusted, so that the difference of the content of free lithium inside the roller kiln measured per unit time between the debugging production line for positive electrode material of a lithium-ion battery and the normal production line for positive electrode material of a lithium-ion battery were less than 0.1%.

### Example 4

The method for debugging a production line for positive electrode material of a lithium-ion battery in Example 3, and LL5503 (LiNi_{0.55}Co_{0.12}Mn_{0.33}O₂) positive electrode materials manufactured by applicant's company were used in the debugging production line. The debugging method of the present disclosure was compared with the debugging method of the new production line being commonly used in the industry which characterizes the indicators of the material after one-time high temperature sintering, until the technical indicators of the products of the two production lines tend to be at the same level. As a result, the debugging method of the present disclosure reduced the unqualified materials resulted from debugging by 50% and time-consuming by 60%.

### Example 5

The method for debugging a production line for positive electrode material of a lithium-ion battery in Example 3, and LL5515 (LiNi_{0.55}Co_{0.06}Mn_{0.39}O₂) positive electrode materials manufactured by applicant's company were used in the debugging production line. The debugging method of the present disclosure was compared with the debugging method of the new production line being commonly used in the industry which characterizes the indicators of the material after one-time high temperature sintering, until the technical indicators of the products of the two production lines tend to be at the same level. As a result, the debugging method of the present disclosure reduced the unqualified materials resulted from debugging by 35% and time-consuming by 40%.

### Example 6

The method for debugging a production line for positive electrode material of a lithium-ion battery in Example 3 was adopted, and LL6506 (LiNi_{0.65}Co_{0.07}Mn_{0.28}O₂) positive electrode materials manufactured by applicant's company were used in the debugging production line. The debugging method of the present disclosure was compared with the debugging method of the new production line being commonly used in the industry which characterizes the indicators of the material after one-time high temperature sintering, until the technical indicators of the products of the two production lines tend to be at the same level. As a result, the debugging method of the present disclosure reduced the unqualified materials resulted from debugging by 40% and time-consuming by 50%.

The above-mentioned examples are the preferred embodiments of the present disclosure, but they do not limit the embodiments of the present invention, and any other changes, modifications, substitutions, combinations and simplification of them, made without departing from the spirit or principle of the present invention should be deemed as equivalent substitutions, and being included in the protection scope of the present invention.

1. A production line for a positive electrode material of a lithium-ion battery, comprising:
a roller kiln;
a gas collecting device, communicated with the roller kiln and configured to collect gas inside the roller kiln; and
a free lithium-measuring device, configured to measure content of free lithium in the gas collected by the gas collecting device.

2. The production line for a positive electrode material of a lithium-ion battery according to claim 1, wherein the gas collecting device is communicated with a zero pressure position of the roller kiln, to collect the gas at the zero pressure position of the roller kiln.

3. The production line for a positive electrode material of a lithium-ion battery according to claim 1, wherein a gas filtering device is further connected to the gas collecting device.

4. The production line for a positive electrode material of a lithium-ion battery according to claim 3, wherein a filter membrane, with a pore size of 400-500 nm, is provided inside the gas filtering device.

5. The production line for a positive electrode material of a lithium-ion battery according to claim 1, wherein the free lithium-measuring device is a potentiometric titrator.

6. A method for producing a positive electrode material of a lithium-ion battery, comprising a step of monitoring free lithium in gas inside a roller kiln during sintering of a positive electrode material of a lithium-ion battery.

7. The production method for a positive electrode material of a lithium-ion battery according to claim 6, comprising steps of: collecting gas inside the roller kiln by a gas collecting device and measuring content of free lithium in the collected gas by a free lithium-measuring device, during sintering of a positive electrode material of a lithium-ion battery.

8. The production method for a positive electrode material of a lithium-ion battery according to claim 7, wherein time for single collection of the gas inside the roller kiln by the gas collecting device is 0.2-5 h.

9. The production method for a positive electrode material of a lithium-ion battery according to claim 8, the time for single collection of the gas inside the roller kiln by the gas collecting device is 0.5-2 h.

10. A method of debugging a production line for a positive electrode material of a lithium-ion battery, comprising steps of:
monitoring free lithium in gas inside a roller kiln during sintering of a positive electrode material of a lithium-ion battery at a normal production line for a positive electrode material of a lithium-ion battery and a debugging production line for a positive electrode material of a lithium-ion battery respectively, and
adjusting intake and exhaust parameters of the debugging production line for a positive electrode material of a lithium-ion battery, to control content of free lithium in the debugging production line for a positive electrode material of a lithium-ion battery to be at the same level as that in the normal production line for a positive electrode material of a lithium-ion battery.
